(19) United States
(12) Patent Application Publication
(10) Pub. No.: US 2004/0010554 A1
(43) Pub. Date: Jan. 15, 2004

(54) Determining a destination e-mail address for sending scanned documents

(76) Inventors: John M. Hall, Boise, ID (US); Craig G. McCoy, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/196,397

(22) Filed: Jul. 15, 2002

(51) Int. Cl. G06F 15/16

(52) U.S. Cl. 709/206; 709/245

(57) ABSTRACT

A method, device, and computer media for a user of a digital sending device specifies the value of an attribute of a destination e-mail account. Some examples of attribute values easily keyable into a digital sending device are PINs and telephone numbers. A directory services query or search is then made for the destination e-mail account having that attribute/value pair. Standardized directory services such as LDAP or X.500 may be utilized, as well as proprietary directory services. The e-mail address of the destination e-mail account found in the directory services query is then used to send e-mail containing scanned documents from the digital sending device.

### CROSS REFERENCE TO RELATED APPLICATIONS

This application is related to our co-pending patent applications filed of even date herewith, assigned to Hewlett-Packard Company, and:

Titled: “METHOD AND SYSTEM FOR PROVIDING AUTOMATIC AUTHENTICATION FOR DIGITAL SENDING DEVICES” by Craig G. McCoy and John M. Hall with attorney docket number 10016328-1; and

Titled: “METHOD AND SYSTEM FOR PROVIDING E-MAIL RECEIPT UTILIZING SHARED MULTIFUNCTION DEVICES” by Craig G. McCoy and John M. Hall with attorney docket number 10016346-1.

### FIELD OF THE INVENTION

The present invention generally relates to digital sending devices and, more specifically, to querying directory services such as LDAP or X.500 for user-specified attribute values to determine the destination e-mail address for use in digitally sending scanned documents.

### BACKGROUND OF THE INVENTION

Modern businesses rely on being able to transfer document images from one location to another. With the adoption of Group 3 digital standards in 1980 by the Comité Consultatif International Téléphonique et Télégraphique (CCITT) (or the International Telegraph and Telephone Consultative Committee), facsimile (FAX) devices have become extremely prevalent in offices. Facsimile devices typically operate by scanning a document line by line to detect light and dark areas. These light and dark areas are then converted into binary digits. A representation of these light and dark areas is then transmitted across a telephone line to a receiving unit that in turn uses the received representation to generate dots on paper. The result is a reasonably good copy of the original document. Originally, facsimile printers typically utilized thermal paper imaging. More recently, laser and ink jet printing of incoming facsimile copies has become common. Also, many computer modems support the Group 3 digital standard, and thus allow computers to operate both to send and to receive facsimile copies of documents.

Facsimile transmission of copies of documents works reasonably well. However, a number of problems have been identified. One problem that has been identified is that facsimile copies often do not provide the level of image resolution that some applications require. Another problem is that facsimile transmissions typically consume more transmission bandwidth than may be necessary. This is compounded by the problem that, in most cases, facsimile transmissions utilize an entire circuit-switched connection, as contrasted to sharing of circuits as is found in packet-switching solutions.

One solution to these problems that has been found arose naturally from the use in many instances of computers on both ends of facsimile transmissions. On the one end of a connection, a computer emulates a facsimile transmitter, and on the other end, another computer emulates a facsimile receiver. Standard computer scanners can be utilized to scan in documents. Similarly, standard computer printers can be utilized to print out received documents. In between, digital images of the documents are converted to the required Group 3 standard format before transmission and then converted from the Group 3 standard to a standard computer output format before being printed.

One solution is termed “Digital Sending”. Digital sending eliminates the conversions from and to the Group 3 standard. Instead, a document is scanned into a standard internal computer image format, such as Portable Document Format (PDF) from Adobe Systems Incorporated, Tagged Image File Format (TIFF), Joint Photographic Experts Group (JPEG) format, Bit-Map (BMP) format from Microsoft Corporation, etc. The document is then transmitted to a receiving system in the specified internal computer image format, where it can be manipulated, stored, or printed, as desired. While a transmission can be over a circuit-switched network, it is more frequently done over a packet-switched network, such as the Internet, or a corporate intranet. Typically, documents are transmitted as e-mail file attachments.

Originally, digital sending mirrored the typical e-mail environment. An e-mail message with one or more attached documents would be sent from one computer to another. However, as the cost of processing power continues to decline, it has become cost effective to utilize commodity processors in some auxiliary or peripheral devices such as printers and scanners. At the same time, these auxiliary devices are frequently being connected directly to networks instead of computers in order to more easily provide sharing of such among multiple computers and computer users. One result of this is that these auxiliary devices can now support functions such as e-mail that previously were limited to computers.

The incorporation of e-mail capabilities within auxiliary devices such as printers and scanners allows these devices to be utilized in digital sending. A scanner can be used to scan a document into a specified format and then to transmit that document as an e-mail attachment to a recipient. Similarly, a printer can receive an e-mail containing a document in a particular format and print it out. Especially useful for digital sending are all-in-one or multifunction devices that provide scanning and printing, and even facsimile transmissions. Some current examples of stand-alone devices capable of digital sending and/or receiving are the 9100C digital sending device and the LaserJet 8150 multifunction device from Hewlett-Packard Company of Palo Alto, Calif.

One problem that remains is that of addressing e-mail being sent from a digital sending device. These digital sending devices currently typically have limited controls. Thus, for example, specifying an alphanumeric destination as is typically required to address e-mail is cumbersome at best. The result currently is that e-mail messages sent from a digital sending device are typically sent to a fixed destination e-mail account.

It would be advantageous to provide a mechanism that would allow for easier and more flexible routing of e-mail containing scanned documents from a digital sending device.

### BRIEF SUMMARY OF THE INVENTION

A method, device, and computer media for a user of a digital sending device to specify the value of an attribute of a destination e-mail account. Some examples of attribute values easily keyable into a digital sending device are personal identification (PIN) and telephone numbers. A directory services or database query or search is then made for the destination e-mail account having that attribute/value pair. Standardized directory services such as Lightweight Directory Access Protocol (LDAP) or X.500 may be utilized, as well as proprietary directory services. The e-mail address of the destination e-mail account found in the directory services query is then used to send email containing scanned documents from the digital sending device to a digital receiving device.

### BRIEF DESCRIPTION OF THE DRAWINGS

FIG. 1 is a block diagram of an exemplary digital sending device;

FIG. 2 is a block diagram illustrating a network containing a digital sending device, in accordance with one embodiment of the present invention;

FIG. 3 is a block diagram illustrating an exemplary general purpose computer such as a server shown in FIG. 2; and

FIG. 4 is a flowchart illustrating operation of an embodiment of the present invention.

### DETAILED DESCRIPTION OF THE INVENTION

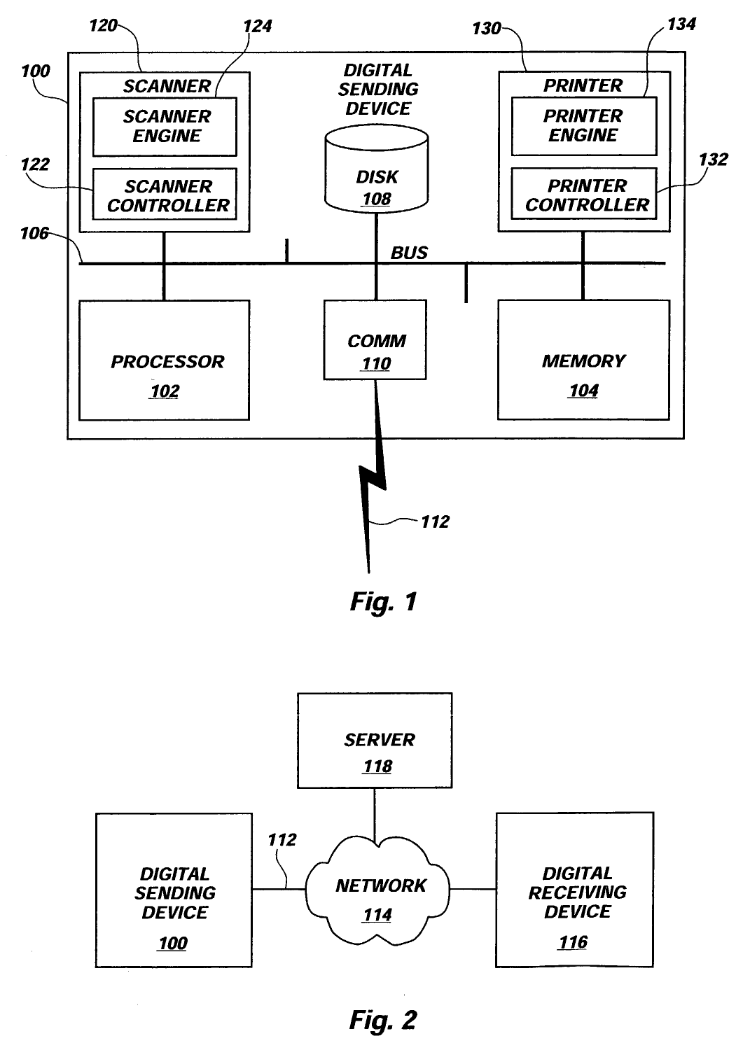

FIG. 1 is a block diagram of an exemplary digital sending device 100. The digital sending device 100 preferably comprises: a processor 102, memory 104, scanner components 120, printer components 130, and a communications interface 110, all coupled by a bus 106. Also, alternatively included in the digital sending device 100 and coupled to the other components by the bus 106 is secondary storage 108.

The memory 104 is a relatively high-speed, machine-readable medium and comprises volatile memories, such as DRAM and SRAM, and/or nonvolatile memories, such as ROM, FLASH, EPROM, and EEPROM. Secondary storage 108 includes machine-readable media such as: hard disk drives (or DASD) and disk subsystems, floppy disks, removable hard drives, magnetic tapes, CD-ROM, and/or other computers, possibly connected via a communications line. Computer instructions comprising software such as digital sending device 100 control software and directory services client software can be stored in a computer instruction storage medium such as volatile memory, nonvolatile memory, or secondary storage. Executable versions of computer instructions can be read from a computer readable storage medium such as secondary storage and nonvolatile memory and loaded for execution directly into volatile memory, executed directly out of nonvolatile memory, or stored on the secondary storage prior to loading into volatile memory for execution.

The scanner components 120 comprise scanner control logic 122 and a scanner engine 124. The scanner control logic 122 controls the operation of the scanner engine 124. The printer components 130 comprise printer control logic 132 and a printer engine 134. The printer control logic 132 controls the operation of a printer engine 134. The scanner engine 124 and the printer engine 134 are the electromechanical portions of the scanner components 120 and printer components 130, respectively.

The processor 102 is preferably a commodity processor, such as a MIPS® RISC processor currently utilized by Hewlett-Packard Company in some of its multifunction devices. Alternatively the processor 102 may be a custom processor. The processor 102 controls operation of the digital sending device 100 through execution of computer instructions fetched from memory 104.

The communications interface 110 provides communications between the digital sending device 100 and other computers and devices. Typically, the communications interface 110 provides an electronic and protocol interface to a communications link 112. In the preferred embodiment, the communications link 112 is to a local area network such as an Ethernet network. However, other types of communications links 112 are also within the scope of this invention. For example, the communications link 112 may utilize a DB25/Centronics parallel interface to a computer.

The configuration shown in FIG. 1 is illustrative only. Other configurations are also within the scope of this invention. For example, either the printer components 130 or the scanner components 120 may not be present. Also, the printer control logic 132 and the scanner control logic 122 are shown as separate components from the processor 102. However, this is illustrative only. Some or all of the functionality of the printer control logic 132 and the scanner control logic 122 may be implemented as computer instructions executed by the processor 102. Similarly, though the communications interface 110 is shown as a separate component, it may also be implemented utilizing a portion of the cycles of the processor 102.

FIG. 2 is a block diagram illustrating a network containing a digital sending device 100, in accordance with one embodiment of the present invention. A digital sending device 100 is coupled via a communications link 112 to a digital network 114. Also coupled to the digital network 114 is a server 118 and a digital receiving device 116, which is the designated recipient of a digitally sent document from the digital sending device 100. The server 118 is typically capable of storing documents until being retrieved by users. In the case of a document sent as an e-mail attachment, the server 118 will typically be an e-mail server. Typically, the digital sending device will transmit a scanned document to the server 118, where it will be stored in a spool, until ultimately retrieved by the digital receiving device 116. However, a scanned document may be directly transmitted to a digital receiving device 116.

FIG. 2 shows a single digital network 114 with a single server 118. This is illustrative only. Other configurations are also within the scope of this invention. The single digital network 114 may represent a plurality of actual networks. For example, the digital sending device 100 may contain or be coupled to a wireless data transceiver for transmission of data across a short distance wireless data network such as a Bluetooth network. The digital sending device 100 could then transmit a scanned document to a wireless data hub attached to a physical network such as a corporate Ethernet intranet. The scanned document could then be spooled on a first server on this corporate intranet. The scanned document could then be transmitted across this corporate intranet to an Internet gateway or firewall, where it would then be transmitted across the Internet. It might then cross another Internet gateway or firewall and enter another corporate intranet, to which is coupled a second server to which the scanned document is again spooled. The designated digital receiving device 116 would then retrieve the scanned document from the second server.

In FIG. 2, a single server 118 is shown. It should be understood that this is illustrative only. In many situations, multiple servers will be utilized. One functionality typically implemented on a server 118 is as an incoming e-mail server, such as a Post Office Protocol (POP) version 3 (POP3) e-mail server. Another functionality typically implemented on a server 118 is as an outgoing e-mail server, such as a Simple Mail Transfer Protocol (SMTP) e-mail server. Alternatively, other types of e-mail, such as proprietary e-mail products, are also within the scope of this invention. Another function often implemented on servers 118 is that of security. Another function that may be implemented on a server 118 is as a central repository or database containing a global address book database. Another function that is typically implemented on servers 118 is that of providing directory services such as X.500 or LDAP. Note, however, that though X.500 and LDAP directory services often appear to a user as residing on a single server 118, they are often implemented in a distributed fashion, utilizing a plurality of servers 118.

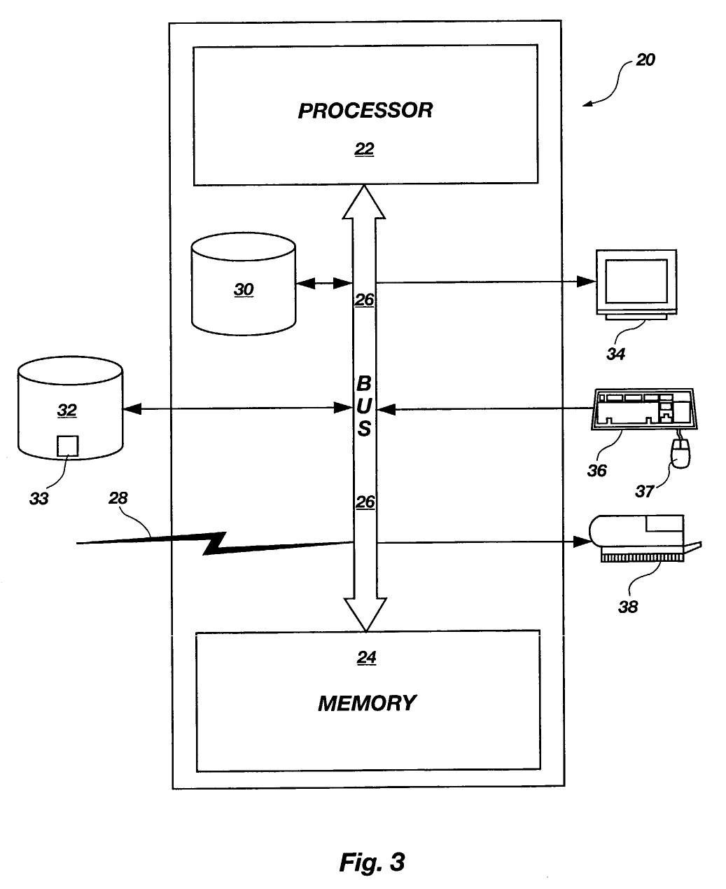

FIG. 3 is a block diagram illustrating an exemplary general-purpose computer 20 such as a server 118 shown in FIG. 2. The general-purpose computer 20 has a computer processor 22 and memory 24, connected by a bus 26. Memory 24 is a relatively high-speed, machine-readable medium and includes volatile memories, such as DRAM and SRAM, and non-volatile memories, such as ROM, FLASH, EPROM, and EEPROM. Also connected to the bus 26 are secondary storage 30, external storage 32, output devices such as a monitor 34, input devices such as a keyboard 36 (with mouse 37), and printers 38. Secondary storage 30 includes machine-readable media such as hard disk drives (or DASD) and disk subsystems. External storage 32 includes machine-readable media such as floppy disks, removable hard drives, magnetic tapes, CD-ROM, and even other computers, possibly connected via a communications line 28. The distinction drawn here between secondary storage 30 and external storage 32 is primarily for convenience in describing the invention. As such, it should be appreciated that there is substantial functional overlap between these elements. Computer software such as printer drivers, operating systems, e-mail servers, directory services, database management, and application programs can be stored in a computer instruction storage medium, such as memory 24, secondary storage 30, or external storage 32. Executable versions of computer software 33 in the form of computer instructions can be read from a computer readable medium such as external storage 32, secondary storage 30, and non-volatile memory and loaded for execution directly into volatile memory, executed directly out of non-volatile memory, or stored on the secondary storage 30 prior to loading into volatile memory for execution.

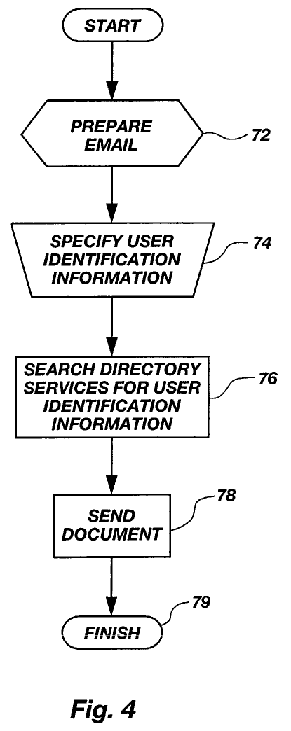

FIG. 4 is a flowchart illustrating operation of an embodiment of the present invention. E-mail is prepared for transmission, step 72. In the case of digitally sending a scanned document, this includes the scanning of the document into an electronic format suitable for transmission by e-mail. The user of the digital sending device 100 then specifies addressing information, step 74. This is typically information that can be utilized to identify the e-mail address to which the e-mail is to be sent. For example, in the case of a digital sending device, this may involve keying in a personal identification number (PIN) or a telephone number on a numeric keypad. A search or query is then made of directory services or a database for that addressing information, step 76. Typically, the directory services or database is located on a server 118. However, it may alternatively be located in the digital sending device 100. Upon receiving a response to the query, the associated destination e-mail address is utilized to address the e-mail, and the e-mail is sent to the digital receiving device 116 associated with the associated destination e-mail address, step 78. The method is then complete, step 79.

FIG. 4 shows a series of steps in a particular order. For example, preparing e-mail for transmission, step 72, is shown prior to specifying address information, step 74. This is illustrative only. Other orders of the steps in this method are also within the scope of this invention. For example, the addressing information may be specified, step 74, prior to the scanning of documents and preparing of e-mail for transmission, step 72. Another alternative is to provide for multiple transmissions of scanned documents from a single sign-on. Thus, a user may only need to specify his addressing information once for the transmission of multiple scanned documents. Other combinations and orderings are also within the scope of this invention.

Directory services are fast becoming the key to the enterprise, allowing applications to locate the resources they need and enabling net managers to authenticate end-users. They provide a mechanism to map between individual attributes and an associated e-mail address. Currently, the two major international standard directory services are X.500 and LDAP. However, proprietary directory services do exist and are also within the scope of this invention.

X.500 is an overall model for Directory Services in the Open Systems Interconnect (“OSI”) world. The model encompasses the overall namespace and the protocol for querying and updating it. The protocol utilized in X.500 is known as “DAP” (Directory Access Protocol). DAP runs over the OSI network protocol stack. The usage of the OSI network protocol stack, combined with its very rich data model and operation set makes X.500 quite “heavyweight” or a heavy computer resource user. As a result of its heavy computer resource usage, X.500 traditionally has not been implemented on desktop computer systems.

“LDAP”, or “Lightweight Directory Access Protocol” is, like X.500, both an information model and a protocol for querying and manipulating it. LDAP's overall data and namespace model is essentially that of X.500. The major difference between LDAP and X.500 is that the LDAP protocol itself is designed to run directly over the TCP/IP stack, and it lacks some of the more esoteric DAP protocol functions present in X.500. Currently, two versions of LDAP are in service, “v2” and “v3”. LDAP v2 is defined by Internet RFCs 1777-1779. LDAP v3 is currently defined by Internet RFCs 2252-2256 and 2829-2830.

A major part of X.500 is that it defines a global directory structure. It is essentially a “directory web” in much the same way that http and html are used to define and implement the “global hypertext web”. Anyone with an X.500 or LDAP client can peruse the global directory just as they can use a web browser to peruse the global Web. Additionally, with the help of web X.500 gateways, people can use their favorite web browser to peruse both.

X.500 and LDAP directories can each be viewed as comprising a plurality of records or sets of attribute/value pairs or tuples. Thus, one record or set of attribute/value pairs or tuples may correspond to a given user. The record or set of tuples may then contain an attribute/value tuple comprising the user's last name, another tuple comprising his first name, another tuple comprising his e-mail address, etc. The attribute is an identifier such as “first name”. The value corresponding to that attribute will then be the first name for that given user. It should be noted that though multiple values in a given record or set may be the same, many directory services logically require that the attributes in a given record or set of tuples each be distinct.

A directory services client can then format a query for an X.500 or LDAP directory located on one or more servers 118 utilizing the appropriate standardized protocols. The query can request that all records containing any combination of attribute/values be returned. For example, a query can be made for an e-mail account associated with a specified telephone number. One of the record attribute values returned from the query will typically be an e-mail address for that e-mail account. This e-mail address can then be utilized to address e-mail messages.

In addition to the standard X.500 and/or LDAP attributes, user extensions can be utilized to search for nonstandardized attributes. For example, one user extension attribute can be a Personal Identification Number (PIN). A directory services search could then be made utilizing this extension attribute and associated value. Thus, the e-mail address associated with a specific PIN can be identified.

The use of PIN and telephone number attribute values has been disclosed hereinabove in the querying directory services. This is illustrative only. Other attribute values are also within the scope of the present invention.

The use of directory services such as X.500 and LDAP has been disclosed for querying for associated e-mail addresses. This is illustrative only. Other mechanisms are also within the scope of the present invention. For example, relational databases are also typically organized as sets of attribute/value tuples. In a typical relational database, a set of attribute/value tuples is considered a row or a record. The attributes form the columns, and the values are the contents of the fields or cells at the intersections of the rows and columns. A relational database column search for a specified value would thus provide similar functionality to X.500 and LDAP directory services. Another alternative is to search a flat file address book entry by entry for the entry containing a specified attribute/value tuple.

A user of a digital sending device specifies the value of an attribute of a destination e-mail account such as a PIN or telephone number. A directory services agent in the digital sending device queries a directory services server for the destination e-mail account having that attribute/value pair. The e-mail address of the destination e-mail account found in the directory services query is used to send e-mail containing scanned documents from the digital sending device to a digital receiving device associated with the destination e-mail account.

This provides a mechanism that allows for easier and more flexible routing of e-mail containing scanned documents from a digital sending device to a digital receiving device. This is especially useful when the digital sending device has a digital keypad, but no alphabetic keys. A numeric attribute value, such as a telephone number or a PIN, can then be utilized to specify the desired destination e-mail account for transmitting documents.

Those skilled in the art will recognize that modifications and variations can be made without departing from the spirit of the invention. Therefore, it is intended that this invention encompass all such variations and modifications as fall within the scope of the appended claims.

What is claimed is:

1. A method of determining a destination e-mail address comprising:
receiving a value as a specified attribute value; and
utilizing the specified attribute value to identify a destination address associated with the specified attribute value.

2. The method in claim 1, further comprising:
addressing a first e-mail message utilizing the destination address.

3. The method in claim 2, further comprising:
transmitting the first e-mail message to a destination associated with the destination address.

4. The method in claim 3, further comprising:
addressing a second e-mail message utilizing the destination address; and
transmitting the second e-mail message to the destination associated with the destination address.

5. A method of determining a destination e-mail address comprising:
receiving a value as a specified attribute value;
utilizing the specified attribute value to identify a destination address associated with the specified attribute value;
addressing a first e-mail message utilizing the destination address addressing a first e-mail message utilizing the destination address;
transmitting the first e-mail message to a destination associated with the destination address;
scanning a document into a computer readable document format as a scanned document; and
attaching the scanned document to the first e-mail message prior to transmitting the first e-mail message.

6. The method in claim 1 wherein:
the utilizing comprises querying an LDAP directory services for the specified attribute value.

7. The method in claim 1 wherein:
the utilizing comprises querying an X.500 directory services for the specified attribute value.

8. The method in claim 1 wherein:
the utilizing comprises querying a relational database for a field containing the specified attribute value.

9. The method in claim 1 wherein:
the specified attribute value comprises one of a PIN and a telephone number.

10. A digital sending device capable of determining a destination e-mail address for use in sending scanned documents comprising:
an input device capable of receiving a value including;
a processor for receiving a value;
a first storage device connected to the processor; and
a second storage device connected to the processor for a computer instruction storage medium including computer instructions for:
receiving the value utilizing the input device as a specified attribute value; and
querying utilizing the specified attribute value to identify a destination address associated with the specified attribute value.

11. The digital sending device in claim 10 wherein the second storage device including the computer instruction storage medium further contains computer instructions for:
addressing a first e-mail message utilizing the destination address.

12. The digital sending device in claim 11 wherein:
the digital sending device further comprises:
a communications interface; and
the second storage device including a computer instruction storage medium further includes computer instructions for:
transmitting the first e-mail message to a destination associated with the destination address utilizing the communications interface.

13. The digital sending device in claim 12 wherein the second storage device including a computer instruction storage medium further includes computer instructions for:
addressing a second e-mail message utilizing the destination address; and
transmitting the second e-mail message to the destination associated with the destination address utilizing the communications interface.

14. The digital sending device in claim 11 wherein:
the digital sending device further comprises:
a scanner engine capable of scanning a document into a scanned document; and
the second storage device including a computer instruction storage medium further includes computer instructions for:
attaching the scanned document to the first e-mail message prior to transmitting the first e-mail message.

15. The digital sending device in claim 10 wherein the computer instructions for querying comprise computer instructions for:
querying an LDAP directory services for the specified attribute value.

16. The digital sending device in claim 10 wherein the computer instructions for querying comprise computer instructions for:
querying an X.500 directory services for the specified attribute value.

17. The digital sending device in claim 10 wherein the computer instructions for querying comprise computer instructions for:
querying a relational database for a field containing the specified attribute value.

18. The digital sending device in claim 10 wherein the input device comprises a digital keypad capable of receiving a digital value.

19. A computer readable medium including computer instructions for:
receiving a value as a specified attribute value from a digital input device; and
utilizing the specified attribute value to identify a destination address associated with the specified attribute value.

20. The computer readable medium of claim 19, further including instructions for:
addressing a first e-mail message utilizing the destination address.

21. The computer readable medium of claim 20, further including instructions for:
transmitting the first e-mail message to a destination associated with the destination address.

22. The computer readable medium of claim 21, further including instructions for:
addressing a second e-mail message utilizing the destination address; and
transmitting the second e-mail message to the destination associated with the destination address.

23. A computer readable medium including computer instructions for:
receiving a value as a specified attribute value;
utilizing the specified attribute value to identify a destination address associated with the specified attribute value;
addressing a first e-mail message utilizing the destination address addressing a first e-mail message utilizing the destination address;
transmitting the first e-mail message to a destination associated with the destination address;
scanning a document into a computer readable document format as a scanned document; and
attaching the scanned document to the first e-mail message prior to transmitting the first e-mail message.

24. The computer readable medium of claim 19, wherein:
the utilizing comprises querying an LDAP directory services for the specified attribute value.

25. The computer readable medium of claim 19, wherein:
the utilizing comprises querying an X.500 directory services for the specified attribute value.

26. The computer readable medium of claim 19, wherein:
the utilizing comprises querying a relational database for a field containing the specified attribute value.

27. The computer readable medium of claim 19, wherein:
the specified attribute value comprises one of a PIN and a telephone number.

28. A digital sending device capable of determining a destination e-mail address for use in sending scanned documents comprising:
means for receiving a value including;
means for processing said value;
first means for storing said value connected to the means for processing said value; and
second means for storage connected to the means for processing, said second means for storing a computer instruction storage medium including computer instructions for:
receiving the value utilizing the input device as a specified attribute value; and
querying utilizing the specified attribute value to identify a destination address associated with the specified attribute value.
